(19) United States
(12) Patent Application Publication
(10) Pub. No.: US 2025/0168857 A1
(43) Pub. Date: May 22, 2025

(54) PDCCH MONITORING SKIPPING AT CORESET LEVEL

(71) Applicant: QUALCOMM Incorporated, San Diego, CA (US)

(72) Inventors: Yongjun KWAK, San Diego, CA (US); Ashutosh Vinod AGRAWAL, Bengaluru, Karnataka (IN); Krishna Kiran MUKKAVILLI, San Diego, CA (US); Prasanth KARUNAKARAN, Erlangen (DE); Deepak MATHEW, Acton, MA (US); Shashidhar VUMMINTALA, Bangalore, Karnataka (IN); Gowrisankar SOMICHETTY, Bangalore, Karnataka (IN)

(21) Appl. No.: 18/840,473

(22) PCT Filed: Apr. 14, 2023
(86) PCT No.: PCT/US2023/065814

§ 371 Date: Aug. 21, 2024

(30) Foreign Application Priority Data
Apr. 29, 2022 (IN) 202241025313

(51) Int. Cl. H04W 72/23; H04L 5/00

(52) U.S. Cl. CPC H04W 72/23; H04L 5/0064; H04L 5/0094

(57) ABSTRACT

Example implementations include a method, apparatus and computer-readable medium for wireless communication at a user equipment, comprising receiving a set of messages indicating a first search space for a first downlink control channel and a second search space for a second downlink control channel, wherein the first and second search spaces overlap in a same slot. The implementations further include refraining from performing blind decoding in either the first or the second search space in the same slot, based on a first priority of a first control resource set (CORESET) associated with the first search space and a second priority of a second CORESET the second search space. Additional example implementations relate to a network entity and include configuring for and indicating to a UE a set of non-overlapping (in a same slot) search spaces of different downlink control channels.

### CROSS REFERENCE TO RELATED APPLICATION(S)

This application claims the benefit of Indian Patent Application number 202241025313, and filed on Apr. 29, 2022, which is assigned to the assignee hereof, and incorporated herein by reference in its entirety.

### BACKGROUND

### Technical Field

The present disclosure generally relates to communication systems, and more particularly, to downlink control channel monitoring.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communication at a user equipment, comprising receiving a set of messages indicating a first search space for a first downlink control channel and a second search space for a second downlink control channel, wherein the first search space overlaps with the second search space in a same slot of a subframe. The method further includes refraining from performing blind decoding in either the first search space or in the second search space in the same slot, based on a first priority of a first control resource set (CORESET) associated with the first search space and a second priority of a second CORESET the second search space.

Another example aspect includes an apparatus for wireless communication at a user equipment, comprising a memory and a processor coupled with the memory. The processor is configured to receive a set of messages indicating a first search space for a first downlink control channel and a second search space for a second downlink control channel, wherein the first search space overlaps with the second search space in a same slot of a subframe. The processor is further configured to refrain from performing blind decoding in either the first search space or in the second search space in the same slot, based on a first priority of a first control resource set (CORESET) associated with the first search space and a second priority of a second CORESET the second search space.

Another example aspect includes an apparatus for wireless communication at a user equipment, comprising means for receiving a set of messages indicating a first search space for a first downlink control channel and a second search space for a second downlink control channel, wherein the first search space overlaps with the second search space in a same slot of a subframe. The apparatus further includes means for refraining from performing blind decoding in either the first search space or in the second search space in the same slot, based on a first priority of a first control resource set (CORESET) associated with the first search space and a second priority of a second CORESET the second search space.

Another example aspect includes a computer-readable medium comprising stored instructions for wireless communication at a user equipment, wherein the instructions are executable by a processor to receive a set of messages indicating a first search space for a first downlink control channel and a second search space for a second downlink control channel, wherein the first search space overlaps with the second search space in a same slot of a subframe. The instructions are further executable to refrain from performing blind decoding in either the first search space or in the second search space in the same slot, based on a first priority of a first control resource set (CORESET) associated with the first search space and a second priority of a second CORESET the second search space.

An example aspect includes a method of wireless communication at a network entity, comprising configuring a set of search spaces of different downlink control channels for a user equipment (UE), wherein each search space in the set of search spaces is configured to not overlap with any other search space in the set of search spaces in a same slot of a subframe. The method further includes indicating to the UE the set of search spaces of the different downlink control channels.

Another example aspect includes an apparatus for wireless communication at a network entity, comprising a memory and a processor coupled with the memory. The processor is configured to configure a set of search spaces of different downlink control channels for a user equipment (UE), wherein each search space in the set of search spaces is configured to not overlap with any other search space in the set of search spaces in a same slot of a subframe. The processor is further configured to indicate to the UE the set of search spaces of the different downlink control channels.

Another example aspect includes an apparatus for wireless communication at a network entity, comprising means for configuring a set of search spaces of different downlink control channels for a user equipment (UE), wherein each search space in the set of search spaces is configured to not overlap with any other search space in the set of search spaces in a same slot of a subframe. The apparatus further includes means for indicating to the UE the set of search spaces of the different downlink control channels.

Another example aspect includes a computer-readable medium comprising stored instructions for wireless communication at a network entity, wherein the instructions are executable by a processor to configure a set of search spaces of different downlink control channels for a user equipment (UE), wherein each search space in the set of search spaces is configured to not overlap with any other search space in the set of search spaces in a same slot of a subframe. The instructions are further executable to indicate to the UE the set of search spaces of the different downlink control channels.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is an example diagram of overlapping search spaces in a same slot.

FIG. 4B is an example diagram of overlapping search spaces in a same slot.

FIG. 5 is a diagram illustrating an example of a hardware implementation for an example apparatus.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating another example of a hardware implementation for another example apparatus.

FIG. 12 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

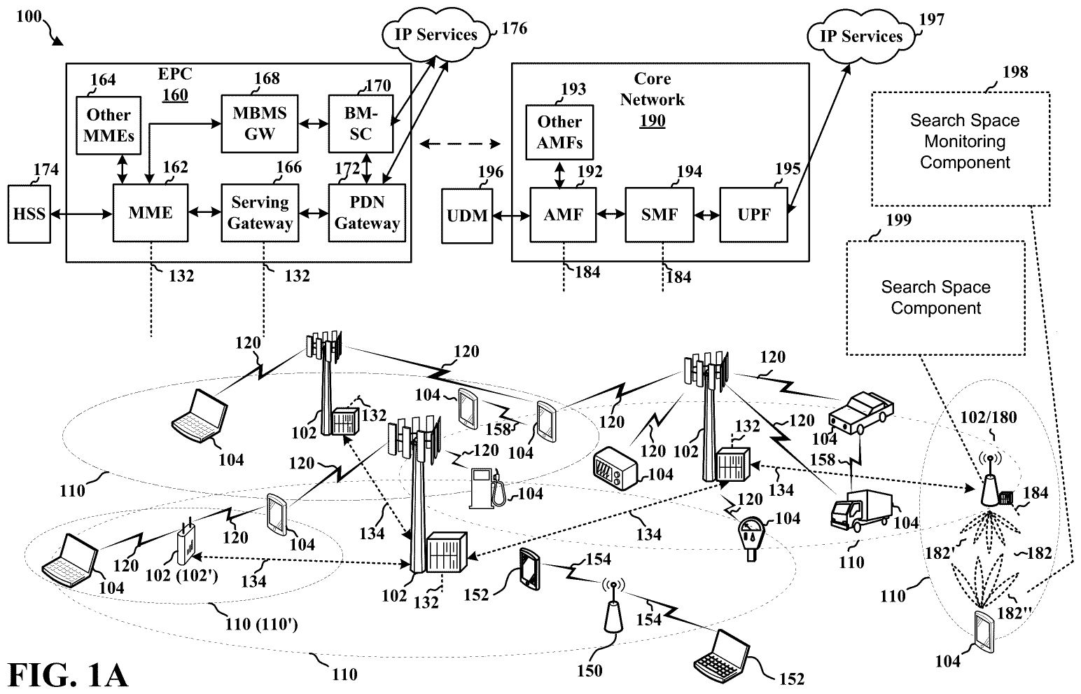

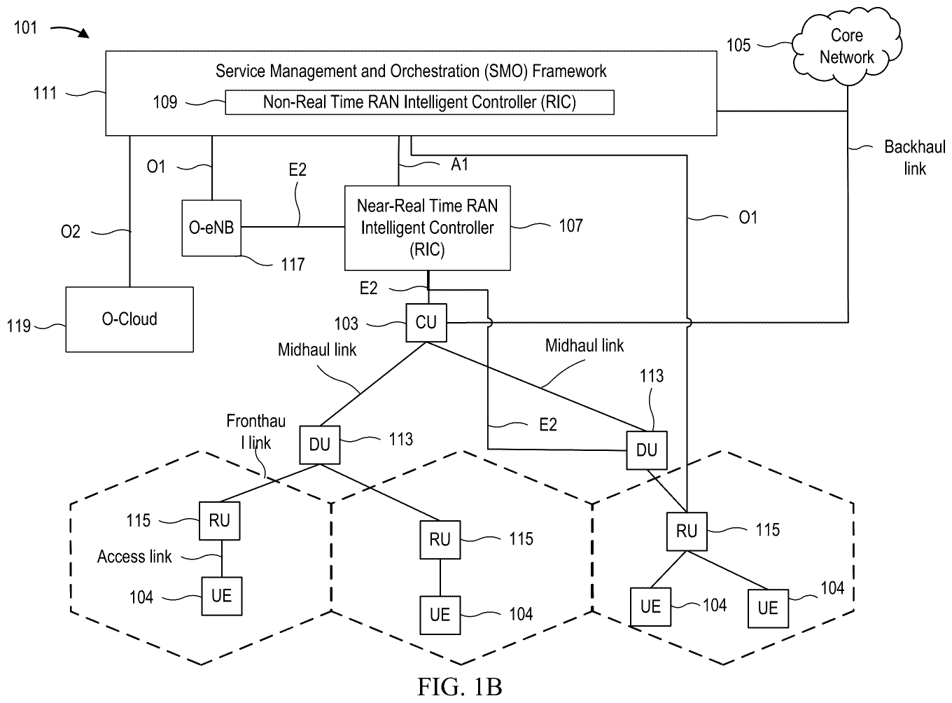

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUS may be implemented within an edge RAN node, and in some aspects, one or more DUs may be co-located with a CU, or may be geographically distributed throughout one or multiple RAN nodes. The DUs may be implemented to communicate with one or more RUs.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1A, in certain aspects, one or more of the UE 104 may include a search space monitoring component 198. The search space monitoring component 198 may include a receiving component 520 and a refraining component 525. The receiving component 520 may be configured to receive a set of messages indicating a first search space for a first downlink control channel and a second search space for a second downlink control channel, where the first search space overlaps with the second search space in a same slot of a subframe. The refraining component 525 may be configured to refrain from performing blind decoding in either the first search space or in the second search space in the same slot, based on a corresponding priority associated with the first search space and the second search space, and based on a first configuration associated with the first search space being different from a second configuration associated with the second search space.

In certain aspects, one or more of the base stations 180 may be configured to include a search space component 199. The search space component 199 may include a configuring component 1120 and an indicating component 1125. The configuring component 1120 may be configured to configure a set of search spaces of different downlink control channels for a user equipment (UE), wherein each search space in the set of search spaces is configured to not overlap with any other search space in the set of search spaces in a same slot of a subframe. The indicating component 1125 may be configured to indicate to the UE the set of search spaces of the different downlink control channels.

FIG. 1B shows a diagram illustrating an example of disaggregated base station 101 architecture. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUS) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUs 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

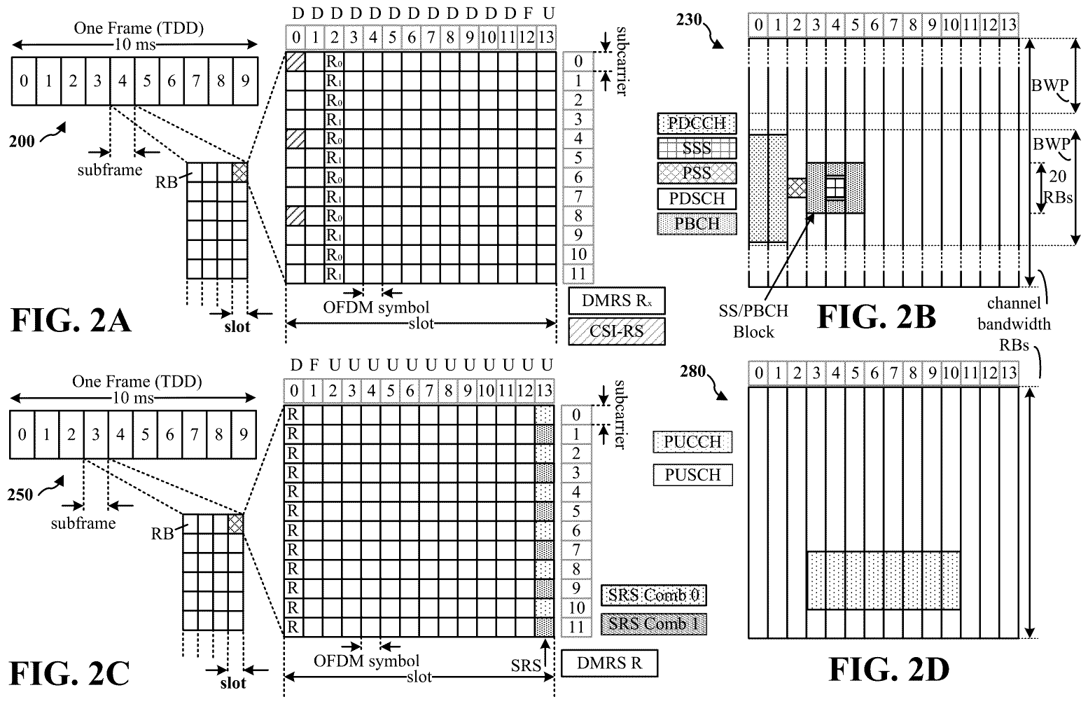

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ} *15 kilohertz (kHz), where u is the numerology μ to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be linked to a control resource set (CORESET). A CORESET may be a set of physical resources (e.g., resource blocks, and the like) and parameters that are used to carry downlink control channel (e.g., PDCCH) and/or control information (e.g., DCI). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

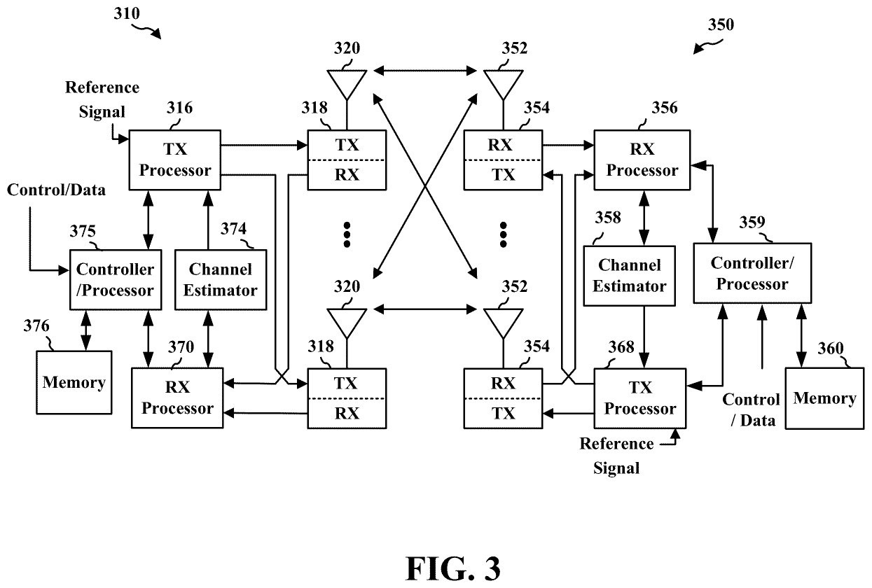

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1A. For example, the memory 360 may include executable instructions defining the search space monitoring component 198. The TX processor 368, the RX processor 356, and/or the controller/processor 359 may be configured to execute the search space monitoring component 198.

At least one of the TX processor 316, the RX processor 370, and the controller/processor 375 may be configured to perform aspects in connection with 199 of FIG. 1A. For example, the memory 376 may include executable instructions defining the search space component 199. The TX processor 316, the RX processor 370, and/or the controller/processor 375 may be configured to execute the search space component 199.

To save device cost, a UE can be configured with reduced capabilities. For example, UEs such as IoT devices (e.g., parking meter, gas pump, toaster, vehicles, monitors, cameras, industrial/manufacturing devices, appliances, vehicles, robots, drones, etc.) can be introduce at a more affordable price if they can be manufactured with reduced capabilities without compromising their performance. Generally, certain performance aspects, such as, bandwidth, peak throughput, power source, power source storage, and the like, of a reduced capability UE may be limited. However, certain aspects of existing techniques for wireless communications between a UE and a network entity can consume significant resources.

For example, to receive, demodulate, and/or decode data on a downlink shared channel, a UE generally uses control information. To obtain such control information, a UE may monitors for downlink control channel (e.g., PDCCH) candidates in a search space associated and/or mapped to a CORESET. However, such monitoring for downlink control channel candidates can significantly increase the total baseband cost of the UE, and this problem is further exacerbated in UEs with reduced capabilities.

Furthermore, a UE can be configured with more than 1 CORESET, and search spaces of the different CORESETs with which a UE is configured can overlap in a given slot in the same BWP. Therefore, existing techniques for downlink control channel monitoring may require monitoring for downlink control channel candidates in search spaces of different CORESETs in the same slot. For example, if a UE is configured with 2 different CORESETs, and the search spaces of both CORESETs overlap in a same slot, then the UE will have to monitor for downlink control channel candidates in search spaces of both the CORESETs in the same slot. Similarly, if the UE is configured with 3 different CORESETs, and the search spaces for all of the 3 CORESET overlap in a same slot, then the UE will have to monitor for downlink control channel candidates in search spaces associated with all of the 3 CORESETs.

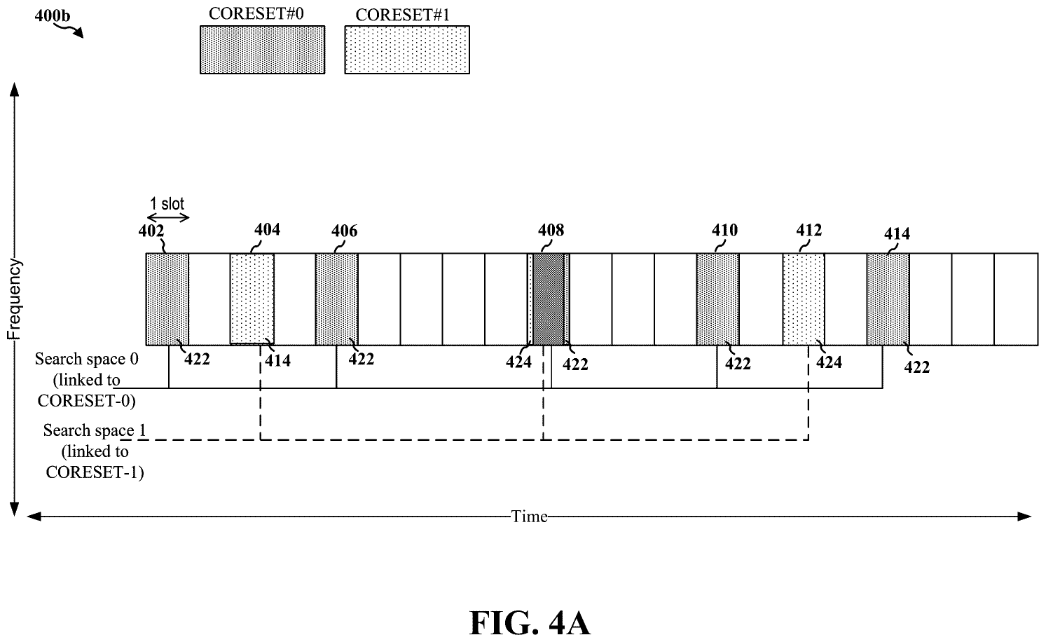

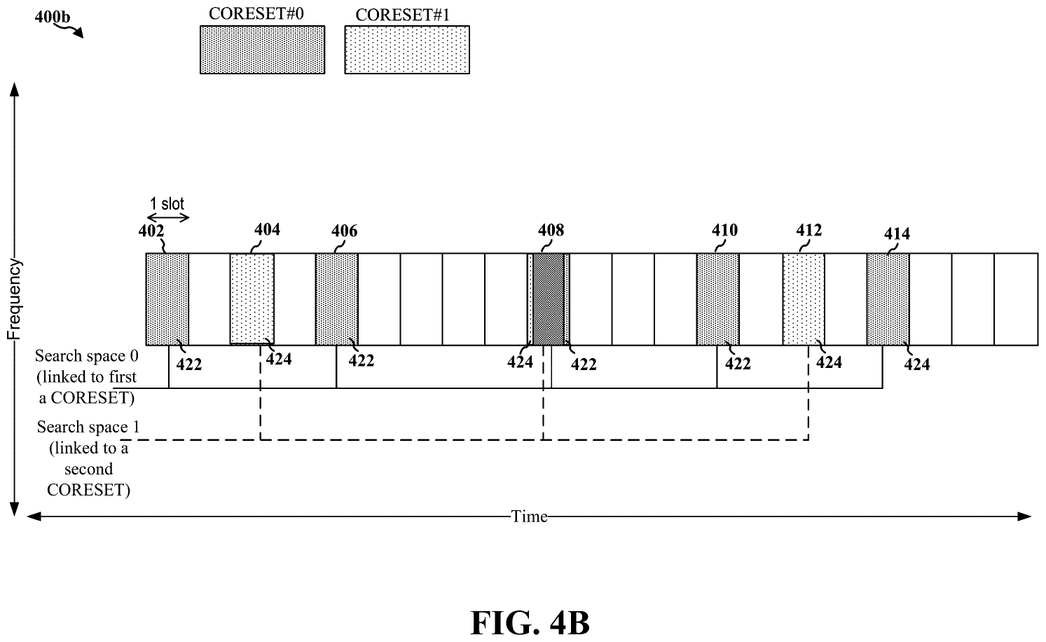

An example of search spaces of different CORESETs overlapping in a same slot in the same BWP is shown in FIG. 4. In FIG. 4, search spaces associated with and/or linked to two different CORESETS, CORESET-0 and CORESET-1, span different slots. For example, search spaces associated and/or linked to CORESET-0 span slots 402, 406, 410, and 414, and search spaces associated with and/or linked to CORESET-1 span slots 404, 408, and 412. Therefore, search spaces of two different CORESETs overlap in slot 408. Thus, in slot 408, existing techniques for downlink control channel monitoring require the UE to monitor for downlink control channels in the search spaces of both CORESET-0 and the CORESET-1. Furthermore, monitoring downlink control channels in search spaces of two different CORESETs in the same slot increases operational complexity of UE and increases processing time and can consume a significant number of computing and processing resources.

Therefore, existing techniques for downlink control channel monitoring in slot can consume a relatively significant percentage of baseband and other computing resources of a UE and an even greater percentage of such resources of a reduced capability UE.

Aspects described herein relate to techniques for reducing the total baseband cost of a UE and improve performance of a UE by improving processing time and consuming fewer processing and computing resources.

As described above, a UE (e.g., UE 104) can be configured with multiple CORESETs per BWP. A CORESET may be a set of physical resources (e.g., resource blocks, and the like) and parameters that are used to carry downlink control channel (e.g., PDCCH) and/or control information (e.g., DCI). A UE may be initially configured with an initial CORESET as part of the configuration of the initial BWP so that the UE may receive system information and/or additional configuration from a network. The UE may receive configuration for the initial CORESET via a message on a broadcast channel. For example, the UE may receive the initial CORESET via MIB on the PBCH. After the UE establishes a connection with a network entity (e.g., base station 102), the UE may be configured for additional CORESETs. The initially configured CORESET may have a CORESET identifier of 0 or an index of 0, and may be a common CORESET. Such an initially configured CORESET will be referred to herein as CORESET-0.

The number of CORESETs a UE can be configured with per BWP may depend on the capability signaling from the UE. For example, a UE may indicate to a network entity how many CORESET configurations it can support per BWP. In some aspects, the UE may indicate to the network entity that it can support up to two downlink control channel (e.g., PDCCH) CORESETs per BWP in addition to the CORESET-0. Similarly, in some aspects the UE may indicate to the network entity that it can support up one downlink control channel (e.g., PDCCH) CORESETs per BWP in addition to the CORESET-0.

Based on the UE capability signaling, the network entity may configure the UE with the corresponding number of CORESETs per BWP. The UE may receive configurations of such CORESETs from the network entity via RRC messages. The network entity may configure the UE with common CORESETs and/or UE-specific CORESETs.

The configuration of a CORESET can indicate the set of resource blocks and the number of symbols available to its search space set. Each search space in a search space set of a CORESET may be mapped to that CORESET, and for a CORESET, a UE may monitor for downlink control channel candidates in the search spaces mapped to that CORESET. The search spaces of the CORESETs that the UE is configured with may be a common search space or a UE-specific search space.

The configuration of a CORESET can indicate to the UE a location of the CORESET and its search space set within a BWP. Based on the configurations of the different CORESETs, the UE may identify whether a search space of one CORESET overlaps a search space of another CORESET in the same slot. For example, with reference to FIG. 4B, the UE determines that the search space 422 of CORESET 430 and search space 424 of CORESET 432 overlap in slot 408 based on the received configurations of CORESET 430 and CORESET 432.

In response to determining that search spaces 422 and 424 of CORESETs 430 and 432 overlap in the same slot 408, the UE, based on priorities associated with the CORESETs 430, 432, may be configured to skip monitoring for downlink control channels in the search space for one of the CORESETs 430, 432 in slot 408. A UE may skip monitoring for a downlink control channel in a search space by refraining from performing a blind decoding for the downlink control channel in that search space. In some aspects, the UE may be configured to associate CORESET-0 with the highest priority, and skips monitoring for downlink control channels in the search spaces of the other CORESETs that overlap with a search space of CORESET-0 in a slot. For example, in FIG. 4B, if CORESET 430 is a CORESET-0, then in slot 408, then, based on the priority of CORESET 430 being highest, the UE skips monitoring for downlink control channel in the search space 424 of CORESET 432 in the slot 408 by refraining from performing blind decoding for the downlink control channel in search 424. In some aspects, the UE may be configured to associate a priority of the CORESET to the search spaces of that CORESET. In some aspects, a UE may determine a priority of a search space of a CORESET based on the priority of the CORESET.

In some aspects, the UE may receive priorities for each of the CORESETs with which it is configured. For example, if a UE is configured with 3 CORESETs per BWP, then the UE may receive from a network entity a priority for each of the 3 CORESETs. The UE may be configured to associate a priority of the CORESET to the search spaces of that CORESET, and the UE may be configured to skip monitoring for downlink control channels in the search space associated with the lower priority in the slot where that lower priority search space is overlapping a higher priority. Continuing with the example of FIG. 4B, if the network entity indicates (e.g., via RRC configuration, RRC messages, and the like) to the UE a higher priority for CORESET 432 than the priority of CORESET 430, then the UE skips monitoring for downlink control channel in the search space 422 of CORESET 430 by refraining to perform blind decoding in the search space 422.

By skipping monitoring for downlink control channels in search spaces of one or more CORSETs in a slot, the UE may consume significantly fewer baseband resources and improves the UE's performance by reducing processing time consumed in monitoring for downlink control channels for different CORESETs.

In some aspects, the UE may be configured to determine whether the configurations of the CORESETs 430 and 432 are the same. In some aspects, the UE may determine that the configurations of the different CORESETs are the same based on values of the parameters indicated in the respective configurations. For example, the UE may determine the configurations are the same when the parameter values indicated in the respective configurations are the same.

In some aspects, the UE may be configured to monitor for downlink control channels in the overlapping search spaces in the same slot if the UE determines that the different CORESETs have the same configurations. For example, in FIG. 4B, if the UE determines that the configurations of CORESET 430 and 432 are the same, then the UE monitors for downlink control channels of CORESET 430 and 432 in slot 408 by performing blind decoding in search space 422 and in search space 424. Since the configurations of the different CORESETS are the same, the number of downlink control channel candidates that the UE monitors for in that slot 408 are reduced. Therefore, the baseband resource cost and/or other computing resources is not increased by performing blind decoding in search space 422 and 424.

In some aspects, all search spaces of CORESETs with which a UE is configured may be linked to CORESET-0. For example, a network entity may configure one or more CORESETs for the UE via RRC and may link each search space in a search space set of each of those CORESETs to CORESET-0 by setting the CORESET identifier in the search space configuration to the identifier of CORESET-0. By linking all search spaces to CORESET-0, the number of downlink control channel candidates that a UE monitors in a slot can be reduced, which can reduce the consumption of baseband resources in the slot and improve performance in that slot.

In some aspects, the network entity may configure the other CORESETs to have the same configuration as CORESET-0. In some aspects, the UE may be configured to update the configurations of the other CORESETs to be the same as configuration of CORESET-0. By configuring the other CORESETs to have the same configuration as the configuration of CORESET-0, the number of downlink control channel candidates that a UE monitors in a slot can also be reduced, which can reduce processing time of monitoring for downlink control channels in a slot, improving UE performance.

In some aspects, for the slots in which search spaces of different CORESETs overlap, then for those slots, the UE may be configured to determine priorities of the different CORESETs and update the configuration of a lower priority CORESET to be the same as the configuration of the higher priority CORESET. For example, in FIG. 4B, if the priority of CORESET 432 is higher than the priority of CORESET 430, then the UE may update the configuration of the CORESET 430 to be the same as configuration of CORESET 432. In those slots, the UE may be configured to perform blind decoding in all the overlapping search spaces. For example, after updating the configuration of CORESET 430 to be the same as configuration of CORESET 432, the UE may perform blind decoding for downlink control channels in both of the search spaces 422 and 424.

In some aspects, network entity may configure each CORESET for a UE in such a manner that a search space of one CORESET does not overlap with a search space of another CORESET. The network entity may configure the parameters of a search space (e.g., periodicity, offset, and the like) in such a manner that a search space of one CORESET does not overlap with search space of another CORESET. For example, if a UE is configured with two CORESETs per BWP, the network may configure the search spaces of first of the two CORESETs to only span even slots and search spaces of second CORESET to only span odd slots. In such aspects, in a single slot, a UE may only have to perform blind decoding in a search space for only one CORESET, which can reduce the number of downlink control channel candidates that a UE monitors in a slot and reduce baseband cost.

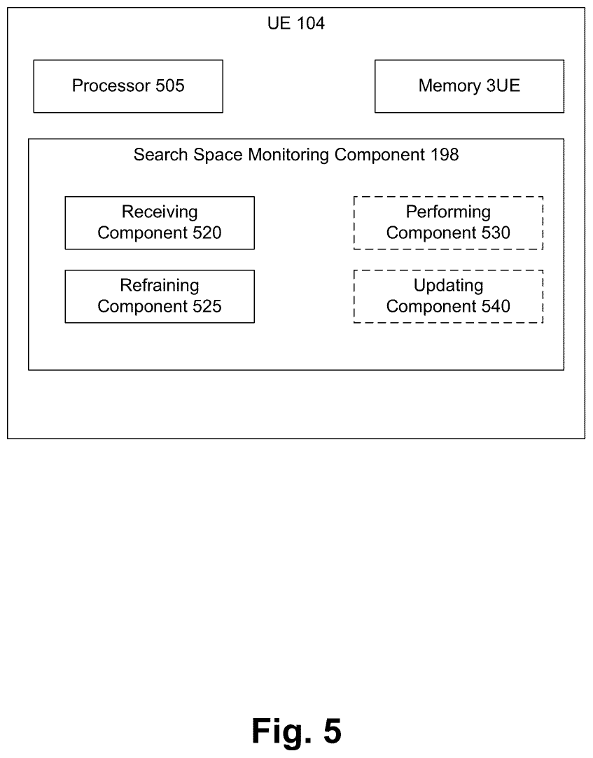

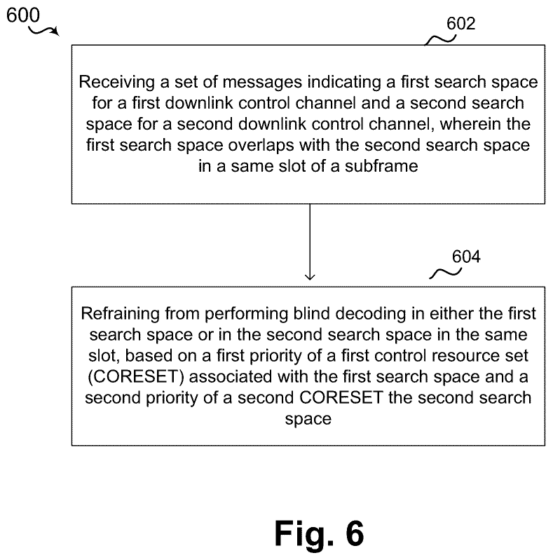

Referring to FIG. 5 and FIG. 6, in operation, UE 104 may perform a method 600 of wireless communication, by such as via execution of search space monitoring component 198 by processor 505 and/or memory 360. In this case, the processor 505 may include any one or any combination of TX processor 368, RX processor 356, and/or controller/processor 359.

At block 602, the method 600 includes receiving a set of messages indicating a first search space for a first downlink control channel and a second search space for a second downlink control channel, wherein the first search space overlaps with the second search space in a same slot of a subframe. For example, in an aspect, UE 104, processor 505, memory 360, search space monitoring component 198, and/or receiving component 520 may be configured to or may comprise means for receiving a set of messages indicating a first search space for a first downlink control channel and a second search space for a second downlink control channel, wherein the first search space overlaps with the second search space in a same slot of a subframe.

For example, the receiving at block 602 may include a MIB message indicating a configuration of an initial CORESET (e.g., CORESET-0) as described above. The receiving at block 602 may include a set of RRC messages indicating configurations of CORESETs that the UE is configured with.

At block 604, the method 600 includes refraining from performing blind decoding in either the first search space or in the second search space in the same slot, based on a first priority of a first CORESET associated with the first search space and a second priority of a second CORESET associated with the second search space. For example, in an aspect, UE 104, processor 505, memory 360, search space monitoring component 198, and/or refraining component 525 may be configured to or may comprise means for refraining from performing blind decoding in either the first search space or in the second search space in the same slot, based on a first priority of the first CORESET associated with the first search space and a second priority of the second CORESET associated with the second search space.

For example, the refraining at block 604 may include not performing the blind decoding in either the first search space or in the second search space in the same slot. Further, for example, the refraining at block 604 may be performed to consume fewer baseband resources of the UE, which can reduce baseband cost of the UE, and reduce processing time for monitoring for downlink control channel candidates, which can improve performance of the UE.

In an optional aspect, the first search space of the first downlink control channel is associated with the first CORESET and the second search space of the second downlink control channel is associated with the second CORESET.

In this aspect, in some cases, the first search space of the first downlink control channel is associated with the first CORESET with the first priority and the second search space of the second downlink control channel is associated with the second CORESET with the second priority, wherein the first priority is different from the second priority.

Moreover, in this aspect, in some cases, the first priority of the first CORESET is higher than the second priority of the second CORESET, and wherein refraining from performing the blind decoding comprises refraining from performing the blind decoding in the second search space of the second downlink control channel associated with the second CORESET.

In another optional aspect, at least one message in the set of messages is a Radio Resource Control message, wherein the at least one message indicates at least one of the first priority of the first CORESET associated with the first search space of the first downlink control channel or the second priority of the second CORESET associated with the second search space of the second downlink control channel.

In another optional aspect, at least one message in the set of messages is a Master Information Block message, wherein the at least one message indicates at least one of the first configuration associated with the first search space of the first downlink control channel or the second configuration associated with the second search space of the second downlink control channel.

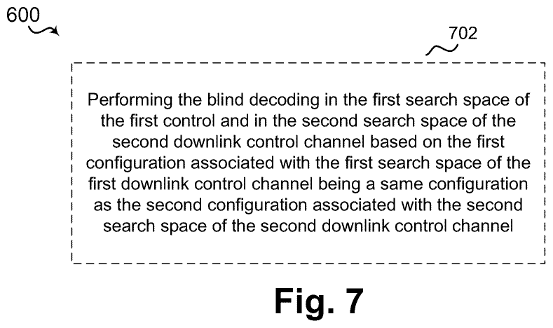

Referring to FIG. 7, in an optional aspect, at block 702, the method 600 may further include performing the blind decoding in the first search space of the first control and in the second search space of the second downlink control channel based on the first configuration associated with the first search space of the first downlink control channel being a same configuration as the second configuration associated with the second search space of the second downlink control channel. For example, in an aspect, UE 104, processor 505, memory 360, search space monitoring component 198, and/or performing component 530 may be configured to or may comprise means for performing the blind decoding in the first search space of the first control and in the second search space of the second downlink control channel based on the first configuration associated with the first search space of the first downlink control channel being a same configuration as the second configuration associated with the second search space of the second downlink control channel.

Further, for example, the performing at block 702 may be performed for the reasons as describe above.

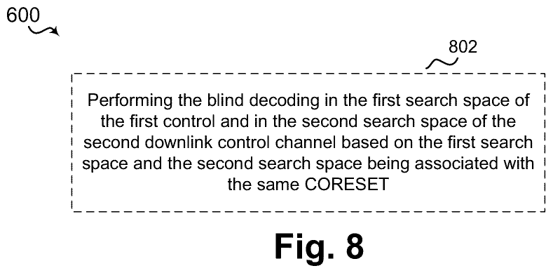

Referring to FIG. 8, in an optional aspect wherein the first search space of the first downlink control channel and the second search space of the second downlink control channel is associated with a same control resource set (CORESET), at block 802, the method 600 may further include performing the blind decoding in the first search space of the first control and in the second search space of the second downlink control channel based on the first search space and the second search space being associated with the same CORESET. For example, in an aspect, UE 104, processor 505, memory 360, search space monitoring component 198, and/or performing component 530 may be configured to or may comprise means for performing the blind decoding in the first search space of the first control and in the second search space of the second downlink control channel based on the first search space and the second search space being associated with the same CORESET.

Further, for example, the performing at block 802 may be performed for the reasons described above.

In this aspect, the first search space and the second search space is linked to CORESET-0.

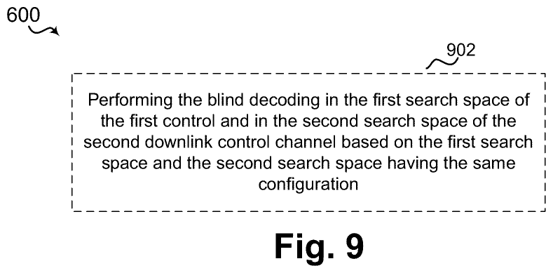

Referring to FIG. 9, in an optional aspect wherein the first search space of the first downlink control channel is associated with control resource set-0 (CORESET-0) and the second search space of the second downlink control channel is associated with a second CORESET different from CORESET-0, wherein the second configuration of the second search space is a same configuration as the first configuration of first search space, at block 902, the method 600 may further include performing the blind decoding in the first search space of the first control and in the second search space of the second downlink control channel based on the first search space and the second search space having the same configuration. For example, in an aspect, UE 104, processor 505, memory 360, search space monitoring component 198, and/or performing component 530 may be configured to or may comprise means for performing the blind decoding in the first search space of the first control and in the second search space of the second downlink control channel based on the first search space and the second search space having the same configuration.

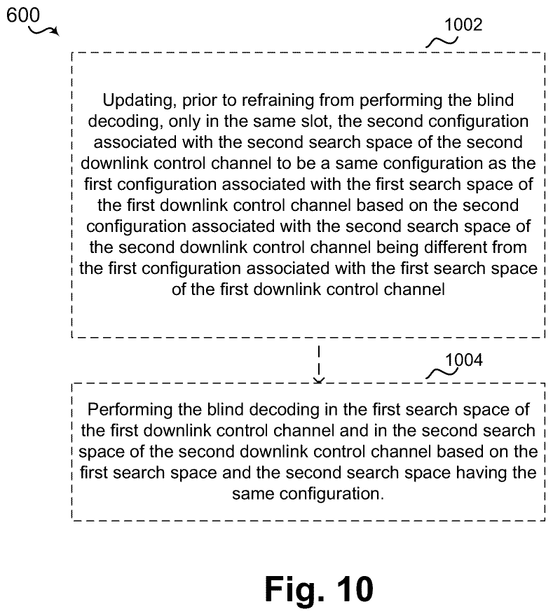

Referring to FIG. 10, in an optional aspect, at block 1002, the method 600 may further include updating, prior to refraining from performing the blind decoding, only in the same slot, the second configuration associated with the second search space of the second downlink control channel to be a same configuration as the first configuration associated with the first search space of the first downlink control channel based on the second configuration associated with the second search space of the second downlink control channel being different from the first configuration associated with the first search space of the first downlink control channel. For example, in an aspect, UE 104, processor 505, memory 360, search space monitoring component 198, and/or performing component 550 may be configured to or may comprise means for updating, prior to refraining from performing the blind decoding, only in the same slot, the second configuration associated with the second search space of the second downlink control channel to be a same configuration as the first configuration associated with the first search space of the first downlink control channel based on the second configuration associated with the second search space of the second downlink control channel being different from the first configuration associated with the first search space of the first downlink control channel.

For example, the updating at block 1002 may include updating, for that slot, parameter values of the second configuration to be the same as the parameter values of the first configuration. Further, for example, the updating at block 1002 may be performed for reasons describe above.

In this optional aspect, at block 1004, the method 600 may further include performing the blind decoding in the first search space of the first downlink control channel and in the second search space of the second downlink control channel based on the first search space and the second search space having the same configuration. For example, in an aspect, UE 104, processor 505, memory 360, search space monitoring component 198, and/or performing component 530 may be configured to or may comprise means for performing the blind decoding in the first search space of the first downlink control channel and in the second search space of the second downlink control channel based on the first search space and the second search space having the same configuration.

Further, for example, the performing at block 1104 may be performed for the reasons described above.

In this aspect, wherein the first priority of the first CORESET associated with the first search space of the first downlink control channel is higher than the second priority of the second CORESET associated with the second search space of the second downlink control channel, then updating, prior to refraining from performing the blind decoding, only in the same slot, the second configuration associated with the second search space is based on the first priority being higher than the second priority.

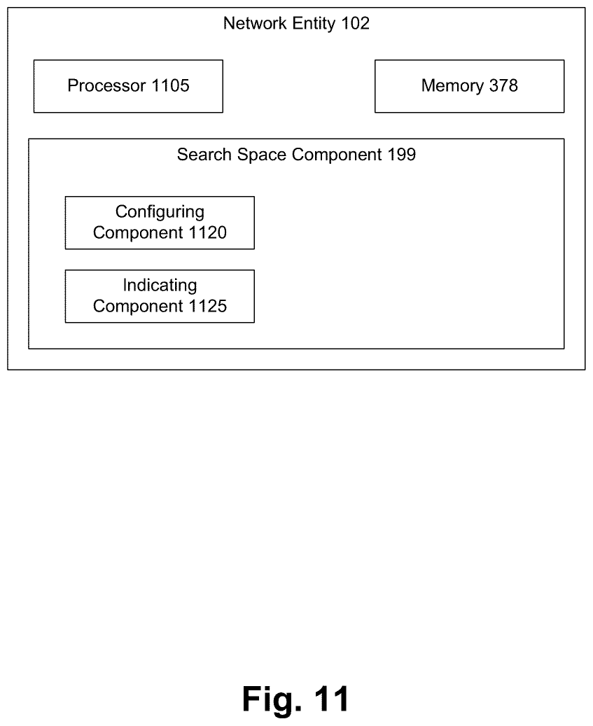

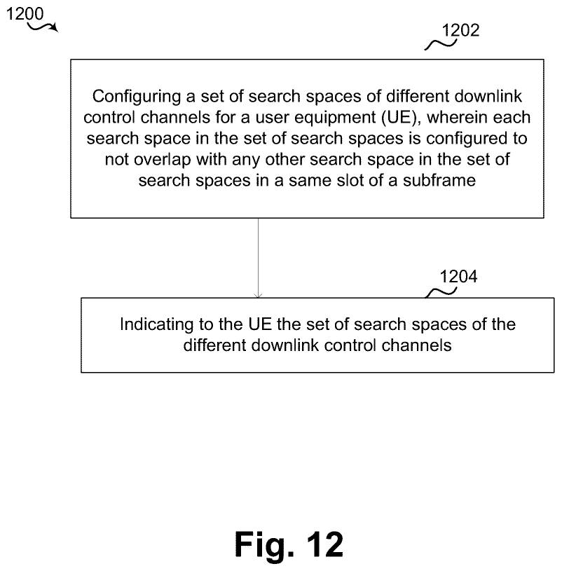

Referring to FIG. 11 and FIG. 12, in operation, network entity 102 may perform a method 1200 of wireless communication, by such as via execution of search space component 199 by processor 1105 and/or memory 376. In this case, the processor 1105 may include any one or any combination of TX processor 316, RX processor 370, and/or controller/processor 375.

At block 1202, the method 1200 includes configuring a set of search spaces of different downlink control channels for a user equipment (UE), wherein each search space in the set of search spaces is configured to not overlap with any other search space in the set of search spaces in a same slot of a subframe. For example, in an aspect, network entity 102, processor 1105, memory 376, search space component 199, and/or configuring component 1120 may be configured to or may comprise means for configuring a set of search spaces of different downlink control channels for a user equipment (UE), wherein each search space in the set of search spaces is configured to not overlap with any other search space in the set of search spaces in a same slot of a subframe.

For example, the configuring at block 1202 may include configuring parameter values (e.g., periodicity, offset, and the like) of CORESETs such that a search space of one CORESET does not overlap with search space of another CORESET.

Further, for example, the configuring at block 1202 may be performed for the reasons described above.

At block 1204, the method 1200 includes indicating to the UE the set of search spaces of the different downlink control channels. For example, in an aspect, network entity 102, processor 1105, memory 376, search space component 199, and/or indicating component 1125 may be configured to or may comprise means for indicating to the UE the set of search spaces of the different downlink control channels.

Referring to FIG. 13, in an optional aspect, at block 1302, the indicating at block 1204 to the UE the set of search spaces further includes transmitting, to the UE, a set of configurations including a respective configuration for each search space of the set of search spaces.

In this aspect, for example, at least one of the set of configurations is transmitted via a Radio Resource Control (RRC) message.

In this aspect, for example, at least one of the set of configurations is transmitted via a Master Information Block (MIB) message.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

Further disclosure is included in the Appendix.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.
1. A method of wireless communication at a user equipment, comprising:
   receiving a set of messages indicating a first search space for a first downlink control channel and a second search space for a second downlink control channel, wherein the first search space overlaps with the second search space in a same slot of a subframe; and
   refraining from performing blind decoding in either the first search space or in the second search space in the same slot, based on a first priority of a first control resource set (CORESET) associated with the first search space and a second priority of a second CORESET associated with the second search space.
2. The method of clause 1, wherein the first search space of the first downlink control channel is associated with the first CORESET and the second search space of the second downlink control channel is associated with the second CORESET.
3. The method of any of the preceding clauses, wherein the first priority of the first CORESET is associated with the first search space of the first downlink control channel and the second priority of the second CORESET is associated with the second search space of the second downlink control channel, wherein the first priority is different from the second priority.
4. The method of any of the preceding clauses, wherein the first priority of the first CORESET is higher than the second priority of the second CORESET, and wherein refraining from performing the blind decoding comprises refraining from performing the blind decoding in the second search space of the second downlink control channel associated with the second CORESET.
5. The method of any of the preceding clauses, wherein at least one message in the set of messages is a Radio Resource Control message, wherein the at least one message indicates at least one of the first priority of the first CORESET associated with the first search space of the first downlink control channel or the second priority of the second CORESET associated with the second search space of the second downlink control channel.
6. The method of any of the preceding clauses, wherein at least one message in the set of messages is a Master Information Block message, wherein the at least one message indicates at least one of a first configuration associated with the first search space of the first downlink control channel or a second configuration associated with the second search space of the second downlink control channel.
7. The method of any of the preceding clauses, further comprising:
performing the blind decoding in the first search space of the first control and in the second search space of the second downlink control channel based on a first configuration associated with the first search space of the first downlink control channel being a same configuration as a second configuration associated with the second search space of the second downlink control channel.
8. The method of any of the preceding clauses, wherein the first search space of the first downlink control channel and the second search space of the second downlink control channel is associated with a same control resource set (CORESET), and further comprising:
   performing the blind decoding in the first search space of the first control and in the second search space of the second downlink control channel based on the first search space and the second search space being associated with the same CORESET.
9. The method of any of the preceding clauses, wherein the first search space and the second search space are linked to CORESET-0.
10. The method of any of the preceding clauses, wherein the first search space of the first downlink control channel is associated with control resource set-0 (CORESET-0) and the second search space of the second downlink control channel is associated with a second CORESET different from CORESET-0, wherein a second configuration of the second search space is a same configuration as a first configuration of first search space, and further comprising:
   performing the blind decoding in the first search space of the first control and in the second search space of the second downlink control channel based on the first search space and the second search space having the same configuration.
11. The method of any of the preceding clauses, further comprising:
   updating, prior to refraining from performing the blind decoding, only in the same slot, a second configuration associated with the second search space of the second downlink control channel to be a same configuration as a first configuration associated with the first search space of the first downlink control channel based on the second configuration associated with the second search space of the second downlink control channel being different from the first configuration associated with the first search space of the first downlink control channel; and
   performing the blind decoding in the first search space of the first downlink control channel and in the second search space of the second downlink control channel based on the first search space and the second search space having the same configuration.
12. The method of any of the preceding clauses, wherein the first priority of the first CORESET associated with the first search space of the first downlink control channel is higher than the second priority of the second CORESET associated with the second search space of the second downlink control channel, and wherein updating, prior to refraining from performing the blind decoding, only in the same slot, the second configuration associated with the second search space is based on the first priority being higher than the second priority.
13. An apparatus for wireless communication at a user equipment, comprising:
   a memory; and
   a processor coupled with the memory and configured to:
      receive a set of messages indicating a first search space for a first downlink control channel and a second search space for a second downlink control channel, wherein the first search space overlaps with the second search space in a same slot of a subframe; and
      refrain from performing blind decoding in either the first search space or in the second search space in the same slot, based on a first priority of a control resource set (CORESET) associated with the first search space and a second priority of a second CORESET associated with the second search space.
14. The apparatus of clause 13, wherein the first search space of the first downlink control channel is associated with the first CORESET and the second search space of the second downlink control channel is associated with the second CORESET.
15. The apparatus of any of the preceding clauses, wherein the first priority of the first CORESET is associated with the first search space of the first downlink control channel and the second priority of the second CORESET is associated with the second search space of the second downlink control channel, wherein the first priority is different from the second priority.
16. The apparatus of any of the preceding clauses, wherein the first priority of the first CORESET is higher than the second priority of the second CORESET, and wherein to refrain from performing the blind decoding comprises to refrain from performing the blind decoding in the second search space of the second downlink control channel associated with the second CORESET.
17. The apparatus of any of the preceding clauses, wherein at least one message in the set of messages is a Radio Resource Control message, wherein the at least one message indicates at least one of the first priority of the first CORESET associated with the first search space of the first downlink control channel or the second priority of the second CORESET associated with the second search space of the second downlink control channel.
18. The apparatus of any of the preceding clauses, wherein at least one message in the set of messages is a Master Information Block message, wherein the at least one message indicates at least one of the first configuration associated with the first search space of the first downlink control channel or the second configuration associated with the second search space of the second downlink control channel.
19. The apparatus of any of the preceding clauses, wherein the processor is further configured to:
   perform the blind decoding in the first search space of the first control and in the second search space of the second downlink control channel based on the first configuration associated with the first search space of the first downlink control channel being a same configuration as the second configuration associated with the second search space of the second downlink control channel.
20. The apparatus of any of the preceding clauses, wherein the first search space of the first downlink control channel and the second search space of the second downlink control channel is associated with a same control resource set (CORESET), and wherein the processor is further configured to:
   perform the blind decoding in the first search space of the first control and in the second search space of the second downlink control channel based on the first search space and the second search space being associated with the same CORESET.

21. The apparatus of any of the preceding clauses, wherein the first search space and the second search space are linked to CORESET-0.
22. The apparatus of any of the preceding clauses, wherein the first search space of the first downlink control channel is associated with control resource set-0 (CORESET-0) and the second search space of the second downlink control channel is associated with a second CORESET different from CORESET-0, wherein the second configuration of the second search space is a same configuration as the first configuration of first search space, and wherein the processor is further configured to:
   perform the blind decoding in the first search space of the first control and in the second search space of the second downlink control channel based on the first search space and the second search space having the same configuration.
23. The apparatus of any of the preceding clauses, wherein the processor is further configured to:
   update, prior to refrain from performing the blind decoding, only in the same slot, the second configuration associated with the second search space of the second downlink control channel to be a same configuration as the first configuration associated with the first search space of the first downlink control channel based on the second configuration associated with the second search space of the second downlink control channel being different from the first configuration associated with the first search space of the first downlink control channel; and
   perform the blind decoding in the first search space of the first downlink control channel and in the second search space of the second downlink control channel based on the first search space and the second search space having the same configuration.
24. The apparatus of any of the preceding clauses, wherein the first priority of the first CORESET associated with the first search space of the first downlink control channel is higher than the second priority of the second CORESET associated with the second search space of the second downlink control channel, and wherein updating, prior to refrain from performing the blind decoding, only in the same slot, the second configuration associated with the second search space is based on the first priority being higher than the second priority.
25. A method of wireless communication at a network entity, comprising:
   configuring a set of search spaces of different downlink control channels for a user equipment (UE), wherein each search space in the set of search spaces is configured to not overlap with any other search space in the set of search spaces in a same slot of a subframe; and
   indicating to the UE the set of search spaces of the different downlink control channels.
26. The method of any of clause 25, wherein indicating to the UE the set of search spaces further comprises:
   transmitting, to the UE, a set of configurations including a respective configuration for each search space of the set of search spaces.
27. The method of any of the preceding clauses, wherein at least one of the set of configurations is transmitted via a Radio Resource Control (RRC) message.
28. The method of any of the preceding clauses, wherein at least one of the set of configurations is transmitted via a Master Information Block (MIB) message.
29. An apparatus for wireless communication at a network entity, comprising:
   a memory; and
   a processor coupled with the memory and configured to:
      configure a set of search spaces of different downlink control channels for a user equipment (UE), wherein each search space in the set of search spaces is configured to not overlap with any other search space in the set of search spaces in a same slot of a subframe; and
      indicate to the UE the set of search spaces of the different downlink control channels.
30. The apparatus of clause 29, wherein to indicate to the UE the set of search spaces the processor is further configured to:
   transmit, to the UE, a set of configurations including a respective configuration for each search space of the set of search spaces.
31. The apparatus of any of the preceding clauses, wherein at least one of the set of configurations is transmitted via a Radio Resource Control (RRC) message.
32. The apparatus of any of the preceding clauses, wherein at least one of the set of configurations is transmitted via a Master Information Block (MIB) message.
33. An apparatus for wireless communication, comprising one or more means for performing the method of clauses 1-12.
34. A computer-readable medium comprising stored instructions for wireless communication, executable by a processor to perform the method of any of the clauses 1-12.
35. An apparatus for wireless communication, comprising one or more means for performing the method of clauses 25-28.
36. A computer-readable medium comprising stored instructions for wireless communication, executable by a processor to perform the method of any of the clauses 25-28.

What is claimed is:

1. A method of wireless communication at a user equipment, comprising:
receiving a set of messages indicating a first search space for a first downlink control channel and a second search space for a second downlink control channel, wherein the first search space overlaps with the second search space in a same slot of a subframe; and
refraining from performing blind decoding in either the first search space or in the second search space in the same slot, based on a first priority of a first control resource set (CORESET) associated with the first search space and a second priority of a second CORESET the second search space.

2. The method of claim 1, wherein the first search space of the first downlink control channel is associated with the first CORESET and the second search space of the second downlink control channel is associated with the second CORESET.

3. The method of claim 2, wherein the first priority of the first CORESET is associated with the first search space of the first downlink control channel and the second priority of the second CORESET is associated with the second search space of the second downlink control channel is associated with the second CORESET, wherein the first priority is different from the second priority.

4. The method of claim 3, wherein the first priority of the first CORESET is higher than the second priority of the second CORESET, and wherein refraining from performing the blind decoding comprises refraining from performing the blind decoding in the second search space of the second downlink control channel associated with the second CORESET.

5. The method of claim 1, wherein at least one message in the set of messages is a Radio Resource Control message, wherein the at least one message indicates at least one of the first priority of the first CORESET associated with the first search space of the first downlink control channel or the second priority of the second CORESET associate with the second search space of the second downlink control channel.

6. The method of claim 1, wherein at least one message in the set of messages is a Master Information Block message, wherein the at least one message indicates at least one of a first configuration associated with the first search space of the first downlink control channel or a second configuration associated with the second search space of the second downlink control channel.

7. The method of claim 1, further comprising:
performing the blind decoding in the first search space of the first control and in the second search space of the second downlink control channel based on a first configuration associated with the first search space of the first downlink control channel being a same configuration as a second configuration associated with the second search space of the second downlink control channel.

8. The method of claim 1, wherein the first search space of the first downlink control channel and the second search space of the second downlink control channel is associated with a same control resource set (CORESET), and further comprising:
performing the blind decoding in the first search space of the first control and in the second search space of the second downlink control channel based on the first search space and the second search space being associated with the same CORESET.

9. The method of claim 8, wherein the first search space and the second search space are linked to CORESET-0.

10. The method of claim 1, wherein the first search space of the first downlink control channel is associated with control resource set-0 (CORESET-0) and the second search space of the second downlink control channel is associated with a second CORESET different from CORESET-0, wherein a second configuration of the second search space is a same configuration as a first configuration of first search space, and further comprising:
performing the blind decoding in the first search space of the first control and in the second search space of the second downlink control channel based on the first search space and the second search space having the same configuration.

11. The method of claim 1, further comprising:
updating, prior to refraining from performing the blind decoding, only in the same slot, a second configuration associated with the second search space of the second downlink control channel to be a same configuration as a first configuration associated with the first search space of the first downlink control channel based on the second configuration associated with the second search space of the second downlink control channel being different from the first configuration associated with the first search space of the first downlink control channel; and
performing the blind decoding in the first search space of the first downlink control channel and in the second search space of the second downlink control channel based on the first search space and the second search space having the same configuration.

12. The method of claim 11, wherein the first priority of the first CORESET associated with the first search space of the first downlink control channel is higher than the second priority of the second CORESET associated with the second search space of the second downlink control channel, and wherein updating, prior to refraining from performing the blind decoding, only in the same slot, the second configuration associated with the second search space is based on the first priority being higher than the second priority.

13. An apparatus for wireless communication at a user equipment, comprising:
a memory; and
a processor coupled with the memory and configured to:
receive a set of messages indicating a first search space for a first downlink control channel and a second search space for a second downlink control channel, wherein the first search space overlaps with the second search space in a same slot of a subframe; and
refrain from performing blind decoding in either the first search space or in the second search space in the same slot, based on a first priority of a control resource set (CORESET) associated with the first search space and a second priority of a second CORESET associated with the second search space.

14. The apparatus of claim 13, wherein the first search space of the first downlink control channel is associated with the first CORESET and the second search space of the second downlink control channel is associated with the second CORESET.

15. The apparatus of claim 14, wherein the first priority of the first CORESET is associated with the first search space of the first downlink control channel is associated with the first CORESET and the second priority of the second CORESET is associated with the second search space of the second downlink control channel, wherein the first priority is different from the second priority.

16. The apparatus of claim 15, wherein the first priority of the first CORESET is higher than the second priority of the second CORESET, and wherein to refrain from performing the blind decoding comprises to refrain from performing the blind decoding in the second search space of the second downlink control channel associated with the second CORESET.

17. The apparatus of claim 13, wherein at least one message in the set of messages is a Radio Resource Control message, wherein the at least one message indicates at least one of the first priority of the first CORESET associated with the first search space of the first downlink control channel or the second priority of the second CORESET associated with the second search space of the second downlink control channel.

18. The apparatus of claim 13, wherein at least one message in the set of messages is a Master Information Block message, wherein the at least one message indicates at least one of the first configuration associated with the first search space of the first downlink control channel or the second configuration associated with the second search space of the second downlink control channel.

19. The apparatus of claim 13, wherein the processor is further configured to: perform the blind decoding in the first search space of the first control and in the second search space of the second downlink control channel based on the first configuration associated with the first search space of the first downlink control channel being a same configuration as the second configuration associated with the second search space of the second downlink control channel.

20. The apparatus of claim 13, wherein the first search space of the first downlink control channel and the second search space of the second downlink control channel is associated with a same control resource set (CORESET), and wherein the processor is further configured to:
perform the blind decoding in the first search space of the first control and in the second search space of the second downlink control channel based on the first search space and the second search space being associated with the same CORESET.

21. The apparatus of claim 20, wherein the first search space and the second search space are linked to CORESET-0.

22. The apparatus of claim 13, wherein the first search space of the first downlink control channel is associated with control resource set-0 (CORESET-0) and the second search space of the second downlink control channel is associated with a second CORESET different from CORESET-0, wherein the second configuration of the second search space is a same configuration as the first configuration of first search space, and wherein the processor is further configured to:
perform the blind decoding in the first search space of the first control and in the second search space of the second downlink control channel based on the first search space and the second search space having the same configuration.

23. The apparatus of claim 13, wherein the processor is further configured to:
update, prior to refrain from performing the blind decoding, only in the same slot, the second configuration associated with the second search space of the second downlink control channel to be a same configuration as the first configuration associated with the first search space of the first downlink control channel based on the second configuration associated with the second search space of the second downlink control channel being different from the first configuration associated with the first search space of the first downlink control channel; and
perform the blind decoding in the first search space of the first downlink control channel and in the second search space of the second downlink control channel based on the first search space and the second search space having the same configuration.

24. The apparatus of claim 23, wherein the first priority of the first CORESET associated with the first search space of the first downlink control channel is higher than the second priority of the second CORESET associated with the second search space of the second downlink control channel, and wherein updating, prior to refrain from performing the blind decoding, only in the same slot, the second configuration associated with the second search space is based on the first priority being higher than the second priority.

25. A method of wireless communication at a network entity, comprising:
configuring a set of search spaces of different downlink control channels for a user equipment (UE), wherein each search space in the set of search spaces is configured to not overlap with any other search space in the set of search spaces in a same slot of a subframe; and
indicating to the UE the set of search spaces of the different downlink control channels.

26. The method of claim 25, wherein indicating to the UE the set of search spaces further comprises:
transmitting, to the UE, a set of configurations including a respective configuration for each search space of the set of search spaces.

27. The method of claim 26, wherein at least one of the set of configurations is transmitted via a Radio Resource Control (RRC) message.

28. The method of claim 26, wherein at least one of the set of configurations is transmitted via a Master Information Block (MIB) message.

29. An apparatus for wireless communication at a network entity, comprising:
a memory; and
a processor coupled with the memory and configured to:
configure a set of search spaces of different downlink control channels for a user equipment (UE), wherein each search space in the set of search spaces is configured to not overlap with any other search space in the set of search spaces in a same slot of a subframe; and
indicate to the UE the set of search spaces of the different downlink control channels.

30. The apparatus of claim 29, wherein to indicate to the UE the set of search spaces the processor is further configured to:
transmit, to the UE, a set of configurations including a respective configuration for each search space of the set of search spaces.

31. The apparatus of claim 29, wherein at least one of the set of configurations is transmitted via a Radio Resource Control (RRC) message.

32. The apparatus of claim 30, wherein at least one of the set of configurations is transmitted via a Master Information Block (MIB) message.
